(19) United States
(12) Patent Application Publication
(10) Pub. No.: US 2010/0045930 A1
(43) Pub. Date: Feb. 25, 2010

(54) VARIABLE FOCUS LENS AND SPECTACLES

(76) Inventors: Joshua David Silver, Oxford (GB); Andrew Robertson, Oxford (GB); Miranda Newbery, Oxford (GB)

Correspondence Address: SUGHRUE MION, PLLC, 2100 PENNSYLVANIA AVENUE, N.W., SUITE 800, WASHINGTON, DC, 20037, US

(21) Appl. No.: 12/446,386

(22) PCT Filed: Oct. 23, 2007
(86) PCT No.: PCT/GB07/04046

§ 371 Date: Oct. 8, 2009

(30) Foreign Application Priority Data
Oct. 23, 2006 (GB) 0621065.2

(51) Int. Cl. G02C 7/08; G02B 3/14

(52) U.S. Cl. 351/168; 359/666

(57) ABSTRACT

A variable focus lens (10) comprises a ring (20) with a front surface and a rear surface. A flexible membrane (40) is held between the front surface of the ring and a generally rigid transparent front cover (50), and a rear cover (60) is mounted on the rear surface of the ring, such that a cavity formed between the flexible membrane and the rear cover can be filled with a liquid. The amount of fluid in the cavity can be varied to vary the curvature of the flexible membrane and so vary the optical characteristics of the lens. The ring is provided with an integral hollow extension (22), whose hollow interior (24) communicates with the cavity and forms a liquid reservoir for the variable focus lens (10). The invention also extends to spectacles using the lens.

The invention relates to a variable focus lens, and to spectacles using the variable focus lens.

Variable focus lenses are well known. They normally consist of a liquid-filled chamber, at least one face of which is formed by a transparent flexible membrane. As liquid is introduced into or removed from the chamber, the flexible membrane is deformed, and its curvature accordingly changes. This change in curvature leads to a change in the optical characteristics and power of the lens. The power of the lens can thus be varied simply by varying the amount of liquid in the chamber.

One type of prior art variable focus lens is disclosed, for example, in WO 96/38744. In this document, the amount of fluid in the lens is adjusted by inserting a syringe through a bung, and using the syringe to add or withdraw fluid. Since spectacle frames for the lenses must still allow the lens to be accessed by the syringe, it will be appreciated that use of this lens can be rather inconvenient in some circumstances.

For variable focus lenses for use in some types of spectacles, for example reading glasses, the required range of correction is quite small, and correction can be achieved across the entire range using a relatively small amount of liquid. This small amount of liquid can be stored in a relatively small reservoir.

According to the invention, there is provided a variable focus lens, comprising a ring with a front surface and a rear surface, a flexible membrane held between the front surface of the ring and a generally rigid transparent front cover, and a rear cover on the rear surface of the ring, such that a cavity formed between the flexible membrane and the rear cover can be filled with a liquid, the amount of fluid in the cavity being capable of being varied to vary the curvature of the flexible membrane and so vary the optical characteristics of the lens; wherein the ring is provided with an integral hollow extension, the hollow interior of said extension communicating with said cavity, and forming a liquid reservoir for the variable focus lens.

With such a lens, the reservoir is integral to the lens, and so there is no need to attach or detach syringes or the like to allow adjustment of the amount of liquid in the cavity and thus the optical characteristics of the lens. In addition, as the reservoir is integral to the lens, there is no need to have a separate duct connecting the reservoir to the lens. In some previous forms of spectacles with variable focus lenses, these ducts have interfered with the folding of the spectacles.

It will be appreciated that the size of the reservoir is constrained, and so this lens is particularly suited to use in reading glasses or similar, where a wide range of correction is not required.

The ring and the rear cover may be formed separately, and this may be desirable in some circumstances, as the ring and the rear cover may have differing material requirements. For example, the rear cover must be transparent, but it may be desirable to form the ring from a stronger opaque material. However, forming the ring and the rear cover as separate parts increase the number of steps required to assemble the lens. Thus, in an alternative form, the ring and the rear cover may be formed integrally.

Preferably, the volume of the reservoir in the extension can be varied, thus varying the curvature of the flexible membrane and so varying the optical characteristics of the lens. Various arrangements can be used; in a preferred form, the reservoir is formed as a hollow bore in the extension, and a plunger is disposed in the hollow bore, such that motion of the plunger towards or away from the ring forces liquid into or out of the cavity.

The invention also extends to variable focus spectacles comprising at least one variable focus lens as described above, provided with control means operatively connected to the plunger, such that operation of the control means causes movement of the plunger. In a preferred form, a handwheel is operatively connected to the plunger, such that rotational motion of the handwheel causes translational movement of the plunger. Thus, rotation of the handwheel will serve to vary the optical characteristics of the lens.

Preferred embodiments of the invention will now be described by way of example only and with reference to the accompanying drawings, in which:

FIG. 1 is an exploded perspective view of an embodiment of a variable focus lens;

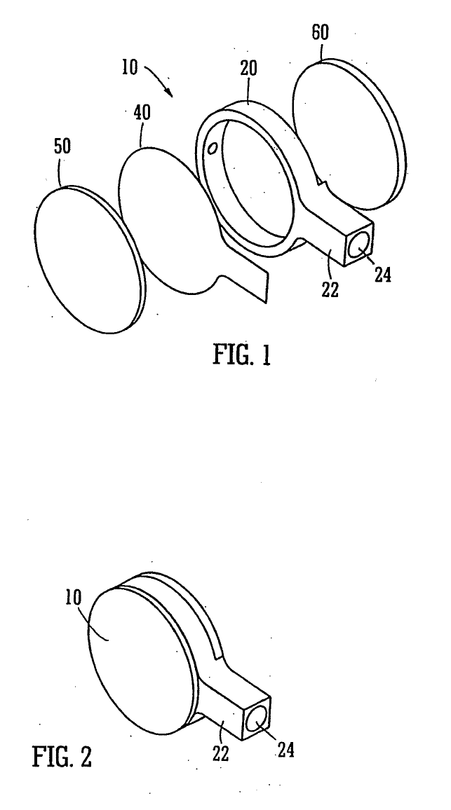

FIG. 2 is a perspective view of the lens of FIG. 1 in its assembled form;

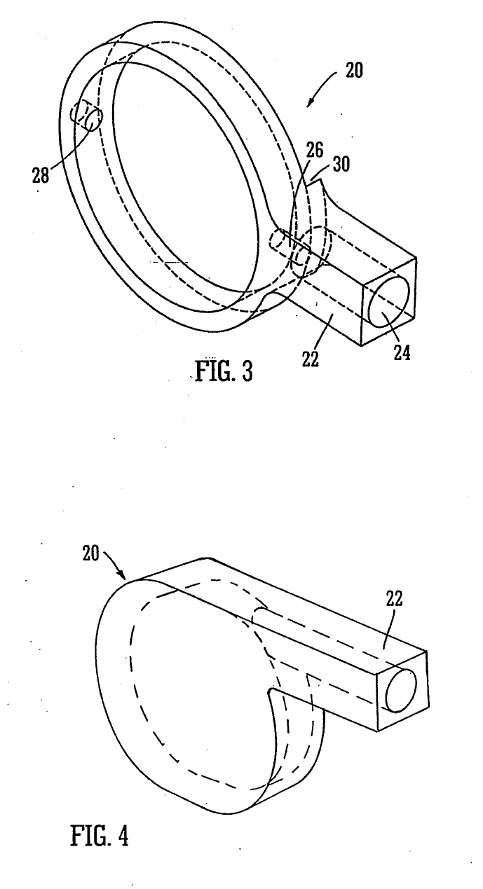

FIG. 3 is a perspective view of a ring for use in such a lens;

FIG. 4 is a schematic view of an alternative form of ring;

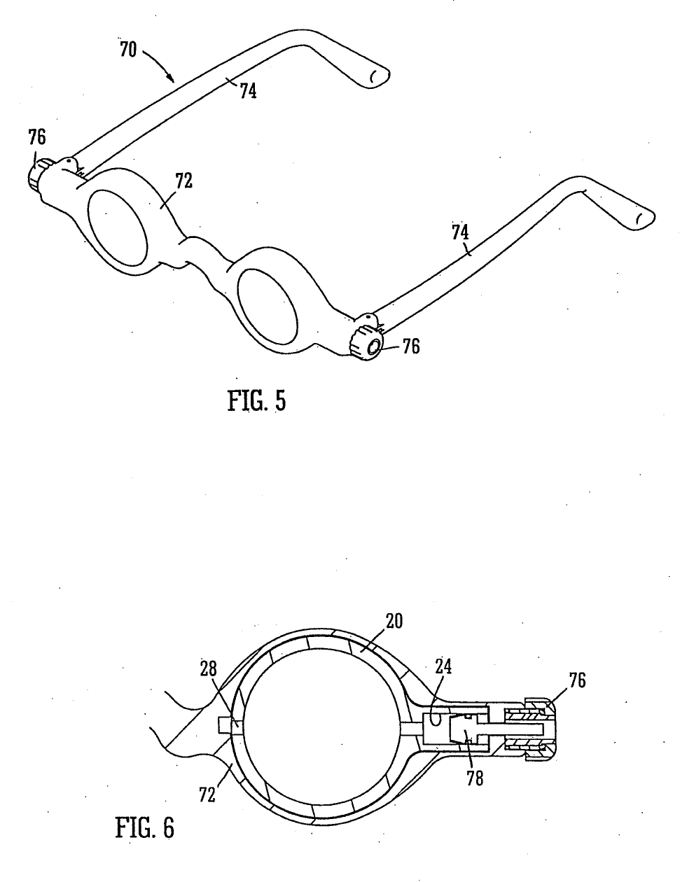

FIG. 5 is a perspective view of a pair of spectacles using two such lenses; and

FIG. 6 is a cross-sectional view of a part of the spectacles of FIG. 4.

As best shown in FIG. 1, the lens 10 is formed from four main parts: a ring 20 (shown in more detail in FIG. 3), a flexible membrane 40, a front cover 50 and a rear cover 60.

The flexible membrane 40 is attached to the front of the ring 20 (ie the side further from a wearer's eye in use), and the rear cover 60 is attached to the rear of the ring 20. Between them, the ring 20, the flexible membrane 40 and the rear cover 60 define a cavity. In use, this cavity is filled with a liquid, and the amount of liquid in the cavity can be varied to change the volume of the cavity. The ring 20 and the rear cover 60 are generally rigid, and so changing the volume of the cavity deforms the flexible membrane 40 and thus varies the optical characteristics of the lens 10. It is preferred for the rear cover 60 to be a lens, which may be made to a particular user's prescription.

The front cover 50 is attached to the membrane 40, so that the membrane 40 is sandwiched between the ring 20 and the front cover 50. The inner surface of the front cover 50 (the surface facing the flexible membrane 40) is curved or otherwise recessed. This provides sufficient space for the flexible membrane 40 to be deformed, and thus allows the power of the lens 10 to be adjusted. It is preferred for the front cover 50 to also be a lens, and like the rear cover, this lens can be made to a particular user's prescription. If desired, the lenses forming the front and rear covers 50, 60 can provide the individual user's prescription in combination.

The ring 20 is shown in mote detail in FIG. 3. The version in FIG. 3 is generally circular, but any appropriate shape can be used. As can be seen, the ring 20 has an integral radial extension 22. In the extension 22 is formed a hollow bore 24, which communicates with the space inside the ring 22 by means of a passage 26. The hollow bore 24 serves as a fluid reservoir for the cavity, allowing liquid to be added into or removed from the cavity through the passage 26 to vary the shape of the flexible membrane 40 and thus the optical characteristics of the lens 10. Further, the hollow bore 24 can accommodate at least part of an adjustment mechanism for varying the amount of fluid in the cavity, as will be described later.

Opposite the extension 22, a fill hole 28 is formed through the ring. This fill hole 28 is used to fill the cavity and the reservoir after assembly of the lens, and is subsequently sealed.

It will be seen that the rear of the ring 20 has a recess 30 to accommodate the rear cover 60. In an alterative form, the rear cover can be formed integrally with the ring.

Although the ring is shown with a radial extension 22, it will be appreciated that the extension need not extend in a radial direction. An alternative form would be for the extension 22 to be generally tangential to the ring 20, as shown schematically in FIG. 4, and it will be appreciated that the layout of the ring can be varied depending on the particular design of the spectacles in which it is to be used.

FIG. 5 shows a pair of spectacles 70 made using two such lenses. The lens on the right of FIG. 5 is in the same orientation as in FIGS. 1 and 2; the lens on the left is identical to that on the right, but has been rotated by 180 degrees about its optical axis. The fact that identical lenses can be used for the left lens and the right lens of the spectacles can reduce the cost of manufacture, as it is only necessary to produce the lens in one form. Further, it will be noted that the lenses are arranged such that radial extensions 22 extend horizontally, from the outer edge of the user's eye.

The lenses 10 are fitted into a frame 72, to which sidearms 74 are attached. Further, handwheels 76 are attached to each side of the frame 72, and each of these handwheels 76 is connected to an adjustment mechanism which allows the focus of the lens 10 to be varied.

One version of the adjustment mechanism is shown in FIG. 5. Here, the adjustment mechanism includes a plunger 78 which can move along the bore 24, thus acting as a piston in a cylinder. Motion of the plunger 78 towards the ring 22 forces liquid into the cavity, which motion of the plunger 78 away from the ring 22 withdraws liquid from the cavity. Changing the amount of liquid in the cavity changes the curvature of the flexible membrane 40, and thus the optical characteristics of the lens 10.

The plunger 78 is operatively connected to the handwheel 76. The handwheel 76 is mounted such that it can rotate, but cannot move along its axis of rotation. Rotational movement of the handwheel is converted into translational movement of the plunger 78.

One way of converting the motion would be to provide the handwheel with an extension with an internal screw thread, which mates with an external screw thread on a rod connected to the plunger. If the plunger is prevented from rotating (for example, by forming the rod with a non-circular section passing through a non-circular opening in the frame, or by forming a flat section on the otherwise cylindrical plunger which co-operates with a corresponding flat section in the bore), then rotational movement of the handwheel and its associated internal screw thread will force the plunger to move along the bore. Of course, any other suitable arrangement could also be used for converting the rotational movement of the handwheel into translational motion of the plunger.

Providing the handwheel 76 at the side of the frame 72 allows easy and convenient adjustment by the user while the spectacles 70 are worn. However, it will be appreciated that other control means can be used; for example, a stepper motor could be used to provide the necessary rotational motion, or a linear actuator could be connected directly to the plunger.

An assembly process for the lens 10 and the spectacles 70 will now be described by way of example only.

Firstly, the ring 20 is moulded or otherwise formed from plastic. A standard ophthalmic quality back lens 60 is bonded onto the ring 20, by applying a thin bead of UV-curing adhesive (such as Loctite 3311 or as equivalent) to the ring 20, then attaching the back lens 60 and curing. This forms the rear lens assembly. In the current embodiment the back lens and ring are formed as separate parts, but as mentioned above, the two could be combined in a single moulded part, which would obviate the need for this step.

A disk of Mylar Type DL1 film 40 is pre-tensioned, using a tensioning rig. Another thin bead of UV-curing adhesive is applied to the front of the rear lens assembly, and this is then placed on the surface of the pre-tensioned Mylar (which can be pre-treated for adhesion). This assembly is allowed to cure.

The assembly, with its Mylar covering, is cut from the tensioning rig, and the Mylar is then trimmed back so that it is flush with the edge of the lens assembly.

A standard ophthalmic quality front lens 50 is then bonded to the Mylar covered rear lens assembly, using a thin bead of UV-curing adhesive applied to the front lens. It is currently preferred for the front lens 50 to be curved, and for the edge of the lens to be prepared for bonding by sanding, to provide an adequate plane surface to bond with the assembly.

Then, the plunger 78 is inserted into the hollow bore 24 of the radial extension 22. As this seals the bore 24, the lens assembly can now be filled with silicone oil (Dow Corning Type 704 or equivalent).

A preferred filling method uses a syringe with an outside diameter smaller than the internal diameter of the fill hole 28; this will allow air to vent as the silicone fluid fills the system. In this preferred method, the plunger 78 is positioned in the bore 24 at its maximum optical power position (with the plunger 78 pushed fully in). The lens assembly is held with the fill hole 28 at the top, and is filled to 50% full. Displaced air can escape through the annulus between the syringe needle and the fill hole 28. The plunger 78 is then moved to the minimum optical power position (with the plunger 78 pulled out), and then back to its maximum power position. This process removes air from the hollow bore 24, and can be repeated if necessary. The remaining volume of the lens cavity is then filled with fluid to overflowing.

Excess silicone oil is wiped away, and a stopper is inserted in the fill hole 28.

In a presently preferred form, the stopper is a polycarbonate rod which is an interference fit with the fill hole 28. The stopper is secured permanently by applying UV-curing adhesive at its joint with the lens assembly and curing.

This will produce a lens assembly; two such assemblies will be required to produce a pair of spectacles.

One of the lens assemblies 10 is then positioned in the spectacle frame front 72. The rod of the plunger 78 is positioned in a slot in the back of the frame front 72, to prevent rotation of the plunger 78 during adjustment operation. The lens 10 may be secured by an interference fit, or an adhesive joint can be used if preferred.

The adjuster assembly is then screwed onto the plunger tail, and the external collar of the adjuster assembly is bonded to the frame front using UV-curing (or similar) adhesive. Then, the handwheel 76 is attached to the internal rotor of the adjuster assembly and secured with an adhesive joint or similar means.

The same steps of inserting the lens assembly 10 and attaching the adjuster assembly are carried out on the second lens.

Finally, left-handed and right-handed sidearms 74 are attached to the frame front 72 to produce the finished spectacles 70.

At present, it is preferred to have the reservoir formed in an extension 22 to the ring 20, partly for ease of manufacture, and partly because it allows the fluid and the plunger 78 to be seen during the filling process (so that the person carrying out the filling process can ensure that there are no air bubbles in the liquid). However, in an alternative form, the reservoir and the plunger could be housed in the frame front itself. This would simplify the structure of the ring (which could be important if it is being moulded with an integral rear lens) at the expense of complicating the structure of the frame.

Of course, variations to the spectacles and the lenses are possible; in particular, there are various ways of connecting the handwheel to the plunger. Further, it is possible to use manual adjusting mechanisms which do not have a handwheel, but a handwheel is currently preferred because of its ease of use.

1. A variable focus lens, comprising a ring with a front surface and a rear surface, a flexible membrane held between the front surface of the ring and a generally rigid transparent front cover, and a rear cover on the rear surface of the ring, such that a cavity formed between the flexible membrane and the rear cover can be filled with a liquid, the amount of fluid in the cavity being capable of being varied to vary the curvature of the flexible membrane and so vary the optical characteristics of the lens;
wherein the ring is provided with an integral hollow extension, the hollow interior of said extension communicating with said cavity, and forming a liquid reservoir for the variable focus lens.

2. A variable focus lens as claimed in claim 1, where the ring and the rear cover are formed integrally.

3. A variable focus. lens as claimed in claim 1, wherein the volume of the reservoir in the extension can be varied, thus varying the curvature of the flexible membrane and so vary the optical characteristics of the lens.

4. A variable focus lens as claimed in claim 3, wherein the reservoir is formed as a hollow bore in the extension, and a plunger is disposed in the hollow bore, such that motion of the plunger towards or away from the ring forces liquid into or out of the cavity.

5. Variable focus spectacles comprising at least one variable focus lens as claimed in claim 4, and provided with control. means operatively connected to the plunger, such that operation of the control means causes movement of the plunger.

6. Variable focus spectacles as claimed in claim 5, wherein a handwheel is operatively connected to the plunger, such that rotational motion of the handwheel causes translational movement of the plunger.

7. Variable focus spectacles comprising at least one variable focus lens comprising a ring with a front surface and a rear surface, a flexible membrane held between the front surface of the ring and a generally rigid transparent front cover, and a rear cover on the rear surface of the ring, such that a cavity formed between the flexible membrane and the rear cover can be filled with a liquid, the amount of fluid in the cavity being capable of being varied to vary the curvature of the flexible membrane and so vary the optical characteristics of the lens;
the lens being accommodated in a frame member of the spectacles, and the frame member also including a reservoir in fluid communication with the cavity, wherein the volume of the reservoir can be varied so as to force liquid into or withdraw liquid from the cavity.

8-9. (canceled)

10. A variable focus. lens as claimed in claim 2, wherein the volume of the reservoir in the extension can be varied, thus varying the curvature of the flexible membrane and so vary the optical characteristics of the lens.
